(19) United States
(12) Patent Application Publication
(10) Pub. No.: US 2025/0301959 A1
(43) Pub. Date: Oct. 2, 2025

(54) EDGE TRIMMING TOOL ASSEMBLY AND POWER TOOL

(71) Applicant: HUSQVARNA AB, Huskvarna (SE)

(72) Inventors: Daniel ALEXANDERSSON, Huskvarna (SE); Anders PERSMEEN, Jonkoping (SE); Johan OLSSON, Jonkoping (SE); Anton NILSSON, Jonkoping (SE)

(21) Appl. No.: 18/865,764

(22) PCT Filed: Mar. 20, 2023
(86) PCT No.: PCT/SE2023/050241

§ 371 Date: Nov. 14, 2024

(30) Foreign Application Priority Data
May 16, 2022 (SE) 2250582-0

(51) Int. Cl. A01G 3/06

(52) U.S. Cl. CPC A01G 3/062

(57) ABSTRACT

An edge trimming tool assembly (1) is disclosed configured to cut vegetation around edge formations (50). The assembly (1) comprises a drive shaft (3) and a trimming tool (5) configured to be rotated around a rotation axis (ax) by the drive shaft (3) such that a radially outer portion (5) of the trimming tool (5) orbits in a circular path (c). The assembly (1) comprises a guard (7) comprising a first guard portion (11) covering a portion of an area (A) formed inside the circular path (c) as seen in a first direction (d1) parallel to the rotation axis (ax) and a second guard portion (12) covering a portion of the area (A) as seen in a second direction (d2) parallel to the rotation axis (ax), wherein the second direction (d2) is opposite to the first direction (d1). The present disclosure further relates to a power tool (2) comprising an edge trimming tool assembly (1).

### TECHNICAL FIELD

The present disclosure relates to an edge trimming tool assembly configured to cut vegetation around edge formations. The present disclosure further relates to a power tool comprising an edge trimming tool assembly.

### BACKGROUND

A trimmer apparatus, also referred to as a string trimmer, line trimmer, and brush cutter, is a type of power tool used for cutting grass and other types of vegetation. A trimmer apparatus comprises a trimming tool with a trimmer line that is rotated fast enough for the centripetal force acting on the trimmer line to stiffen the trimmer line thereby allowing it to cut vegetation upon rotation of the trimming tool. The trimming tool can for example be rotated using an electric motor or an internal combustion engine.

A trimmer apparatus is normally designed to be held such that the trimmer line orbits in a substantially horizontal plane during operation. Moreover, a trimmer apparatus normally comprises a guard covering a top side of the trimming tool for preventing splash of cutting residues and other types of objects and particles from the trimmer apparatus during use thereof.

Some general problems exist when designing power tools, such as trimmer apparatuses. One problem is ergonomics. That is, it is an advantage if a user can use the trimmer apparatus in a simple an ergonomic manner. Another problem is user-friendliness. That is, it is an advantage if the trimmer apparatus is designed such that it can be used in a simple and intuitive manner. Still another problem is the cutting result, which can be defined as uniformity of cutting, where the uniformity of the cutting can be defined as uniformity of a length of the vegetation being cut, i.e., if vegetation of an area is cut to a uniform length.

A further problem is safety. That is, a trimmer apparatus is preferably designed such that it can be used in a safe manner. However, normally, a powerful motor is needed for rotating the trimming tool and high rotational speeds are normally needed for allowing the trimming tool to cut vegetation, which can make it difficult to obtain a trimmer being safe to use, at least for some specific tasks.

One task being challenging to perform with a trimmer apparatus is cutting vegetation around edge formations which comprises more or less vertical sections. An example of such edge formations is edge formations surrounding bunkers on golf courses.

Today, some users use a trimmer apparatus of the above-mentioned type when trimming such edge formations and holds the trimmer apparatus in a non-intended operation position in which the trimmer line orbits in a substantially vertical plane. Such operation may pose a danger to the user and to bystanders, is not ergonomic and may cause an uneven cutting result.

Furthermore, some users, such as greenkeepers of golf courses, convert different tools that can help them to perform edge trimming in a proper way. Those converted products are not developed by professionals for such use. Moreover, they are usually not ergonomic, and the cutting result can be uneven. Furthermore, products converted for another purpose than intended may pose a danger to the user and to bystanders.

Moreover, generally, it is an advantage if products, such as power tools and associated assemblies, have conditions and/or characteristics suitable for being manufactured and assembled in a cost-efficient manner.

### SUMMARY

It is an object of the present invention to overcome, or at least alleviate, at least some of the above-mentioned problems and drawbacks.

According to a first aspect of the invention, the object is achieved by an edge trimming tool assembly configured to cut vegetation around edge formations. The assembly comprising a drive shaft and a trimming tool connected to the drive shaft. The trimming tool is configured to be rotated around a rotation axis by the drive shaft such that a radially outer portion of the trimming tool orbits in a circular path in a rotation plane. The assembly comprises a guard comprising a first guard portion covering a portion of an area formed inside the circular path as seen in a first direction parallel to the rotation axis and a second guard portion covering a portion of the area as seen in a second direction parallel to the rotation axis, wherein the second direction is opposite to the first direction.

Since the guard of the trimming tool assembly comprises the first and second guard portions each covering a portion of the area as seen in respective direction parallel to the rotation axis, a trimming tool assembly is provided having conditions for cutting vegetation around edge formations in a simple, ergonomic, and safer manner, while providing conditions for an improved cutting result.

This is because one of the first and second guard portions can be moved along a more or less vertical section of an edge formation thereby ensuring a predetermined distance between the rotation plane of the trimming tool and the edge formation. By ensuring a predetermined distance between the rotation plane of the trimming tool and the edge formation, the cutting result, i.e., the uniformity of cutting, can be improved. Moreover, a trimming tool assembly is provided requiring less skill of the user for obtaining a more even cutting result around edge formations. In other words, a trimming tool assembly is provided in which the skill of the user has a reduced impact on the cutting result.

Moreover, due to the first and second guard portions of the guard of the trimming tool assembly each covering a portion of the area as seen in respective direction parallel to the rotation axis, a trimming tool assembly is provided allowing a safer and more ergonomic operation of the trimming tool assembly with the trimming tool being held such that the radially outer portion of the trimming tool orbits in a substantially vertical rotation plane.

Accordingly, a trimming tool assembly is provided overcoming, or at least alleviating, at least some of the above-mentioned problems and drawbacks. As a result, the above-mentioned object is achieved.

Optionally, each of the first and second guard portions covers more than 30%, or more than 50%, of the area as seen in the respective first and second directions. Thereby, a trimming tool assembly is provided having conditions for cutting vegetation around edge formations in a simple, ergonomic, and safer manner, while providing conditions for an improved cutting result.

Optionally, each of the first and second guard portions superimposes at least 70% of the other of the first and second guard portions as seen along the respective first and second directions. Thereby, a trimming tool assembly is provided having conditions for cutting vegetation around edge formations in a simple, ergonomic, and safer manner, while providing conditions for an improved cutting result.

Optionally, the trimming tool comprises a tubular elongate support column, wherein the drive shaft is arranged inside the tubular elongate support column and comprises a connection portion for connecting an output shaft of a power unit to the drive shaft. Thereby, a trimming tool assembly is provided having conditions for being used together with a power unit in a simple, safe, ergonomic, and intuitive manner.

Optionally, the guard is attached to an attachment section of the tubular elongate support column, and wherein the angle between the rotation plane a vector pointing from the attachment section towards the connection portion is within the range of 10-85 degrees, or is within the range of 59-79 degrees. Thereby, a trimming tool assembly is provided allowing a safer and more ergonomic operation of the trimming tool assembly with the trimming tool being held in an orientation such that the radially outer portion of the trimming tool orbits in a substantially vertical rotation plane.

Optionally, a portion of the tubular elongate support column located between the attachment section and the connection portion is substantially straight. Thereby, a trimming tool assembly is provided having conditions for being used together with a power unit in a simple, safe, ergonomic, and intuitive manner.

Optionally, the drive shaft is flexible, and wherein the tubular elongate support column has a curved portion. Thereby, a trimming tool assembly is provided having conditions for cutting vegetation around edge formations in a simple, ergonomic, and safe manner, while having conditions and characteristics suitable for being manufactured and assembled in a cost-efficient manner.

Optionally, the curved portion is arranged between the attachment section and the trimming tool. Thereby, a trimming tool assembly is provided having conditions for cutting vegetation around edge formations in a simple, ergonomic, and safe manner, while having conditions and characteristics suitable for being manufactured and assembled in a cost-efficient manner. Moreover, a trimming tool assembly is provided having conditions for being compact.

Optionally, each of the connection portion and the first guard portion is arranged on a first side of the rotation plane. Thereby, a trimming tool assembly is provided having conditions for cutting vegetation around edge formations in a simple, ergonomic, and safe manner.

Optionally, the cutting guard comprises a first edge portion arranged radially outside of the trimming tool, and wherein the first edge portion connects the first and second guard portions. Thereby, a trimming tool assembly is provided having conditions for cutting vegetation around edge formations in an even safer manner. This is because first edge portion can prevent splashing of cutting residues and other types of objects and particles from the trimming tool in radial directions of the trimming tool.

Optionally, the tubular elongate support column is attached to the first edge portion. Thereby, a trimming tool assembly is provided having conditions for cutting vegetation around edge formations in a simple, ergonomic, and safe manner, while having conditions and characteristics suitable for being manufactured and assembled in a cost-efficient manner. Moreover, a trimming tool assembly is provided having conditions for being rigid and durable.

Optionally, the first edge portion is arc-shaped with a radius of curvature being within the range of 80-130% of the distance between the rotation axis and the first edge portion. Thereby, a trimming tool assembly is provided having conditions for cutting vegetation around edge formations in a simple, ergonomic, and safe manner, while having conditions for being compact and light weighted. Moreover, a trimming tool assembly is provided in which the guard is less likely to get stuck, for example in vegetation, during operation.

Optionally, the arc length of the first edge portion is within the range of 50-500%, or is within the range of 100-250%, of the distance between the rotation axis and the first edge portion. Thereby, a trimming tool assembly is provided having conditions for cutting vegetation around edge formations in an even safer manner. This is because first edge portion can prevent splashing of cutting residues and other types of objects and particles from the trimming tool along a great proportion of the circumference of the circular path of the radially outer portion of the trimming tool.

Optionally, the guard comprises a second edge portion arranged opposite to the first edge portion. Thereby, a trimming tool assembly is provided having conditions for cutting vegetation around edge formations in an even safer manner. This is because second edge portion can prevent splashing of cutting residues and other types of objects and particles from the trimming tool in radial directions of the trimming tool.

Optionally, the second edge portion connects first and second guard portions. Thereby, a trimming tool assembly is provided having conditions for cutting vegetation around edge formations in an even safer manner.

Optionally, the second edge portion forms a ground engaging portion for maintaining a predetermined distance between the rotation axis and a ground surface by an abutting contact against the ground surface. Thereby, a trimming tool assembly is provided having conditions for cutting vegetation around edge formations in an even simpler, more ergonomic, and safer manner, while providing conditions for an improved cutting result. This is because the second edge portion can be used to maintain a predetermined distance between the rotation axis and a ground surface adjacent to a more or less vertical section of an edge formation, while one of the first and second guard portions can be used to maintain a predetermined distance between the rotation plane of the trimming tool and the more or less vertical section of the edge formation.

In addition, due to second edge portion forming a ground engaging portion for maintaining a predetermined distance between the rotation axis and a ground surface, a trimming tool assembly is provided in which splashing of objects and particles from the ground surface can be significantly reduced. As an example, when the trimming tool assembly according to embodiments herein is used for cutting vegetation around an edge formation of a golf bunker, the second edge portion can be used to predetermined distance between the rotation axis and a sand surface of the bunker thereby avoiding splash of sand during operation of the trimming tool assembly. Such splashing of sand may pose a danger to the user and to bystanders and may cause an unwanted transfer of sand from the bunker to adjacent grass surfaces.

Optionally, the second edge portion is arc-shaped with a radius of curvature being within the range of 80-130% of the distance between the rotation axis and the second edge portion. Thereby, a trimming tool assembly is provided having conditions for cutting vegetation around edge formations in a simple, ergonomic, and safe manner, while having conditions for being compact and light weighted. Moreover, a trimming tool assembly is provided in which the second guard portion is less likely to get stuck when being moved over surfaces, such as a ground surface, a sand surface of a golf bunker, and the like.

Optionally, the arc length of the second edge portion is within the range of 3-180%, or is within the range of 25-90%, of the distance between the rotation axis and the second edge portion. Thereby, a trimming tool assembly is provided in which the second guard portion can be used to maintain a predetermined distance between the rotation axis and a ground surface in an efficient manner.

Optionally, the guard encloses the trimming tool in a plane parallel to the rotation axis. Thereby, a trimming tool assembly is provided having conditions for cutting vegetation around edge formations in a simple, ergonomic, and safer manner, while having conditions for a rigid and durable guard.

Optionally, the guard comprises a first aperture at a first side of a plane comprising the rotation axis, and wherein the trimming tool has an effective radius being greater than a distance from the rotation axis to edges of the first aperture. Thereby, a trimming tool assembly is provided having conditions for cutting vegetation around edge formations in a simple, efficient, ergonomic, and safe manner, simply by moving the trimming tool assembly such that first aperture at the first side of a plane is moved towards vegetation.

Optionally, the guard comprises a second aperture at a second side of the plane, and wherein the trimming tool has an effective radius being greater than a distance from the rotation axis to edges of the second aperture. Thereby, a trimming tool assembly is provided having conditions for cutting vegetation around edge formations in an even simpler, more efficient, and more ergonomic manner. This is because the trimming tool assembly can be moved such that first aperture at the first side of a plane or the second aperture at the second side of a plane is moved towards vegetation.

Optionally, the trimming tool comprises a bevel gear assembly, and wherein the trimming tool is connected to the drive shaft via the bevel gear assembly. Thereby, a trimming tool assembly is provided having conditions for cutting vegetation around edge formations in a simple, ergonomic, and safe manner, while having conditions and characteristics suitable for being manufactured and assembled in a cost-efficient manner. Moreover, a trimming tool assembly is provided having conditions for being compact.

According to a second aspect of the invention, the object is achieved by a power tool comprising a power unit comprising an output shaft and a motor configured to rotate the output shaft, wherein the power tool comprises an edge trimming tool assembly according to some embodiments of the present disclosure, and wherein the drive shaft of the edge trimming tool assembly is connected, or connectable, to the output shaft of the power unit.

Since the power tool comprises a trimming tool assembly according to some embodiments, a power tool is provided having conditions for cutting vegetation around edge formations in a simple, ergonomic, and safer manner, while providing conditions for an improved cutting result.

Moreover, due to the first and second guard portions of the guard of the trimming tool assembly of the power tool each covering a portion of the area as seen in respective direction parallel to the rotation axis, a power tool is provided allowing a safer and more ergonomic operation with the trimming tool being held such that the radially outer portion of the trimming tool orbits in a substantially vertical rotation plane.

Accordingly, a power tool is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a perspective view of a power tool according to some embodiments of the present disclosure, wherein the power tool comprises a power unit and a trimming tool assembly,

FIG. 2 illustrates an exploded view of some components of the trimming tool assembly illustrated in FIG. 1,

FIG. 3 illustrates the trimming tool assembly illustrated in FIG. 1 as viewed along a second direction indicated in FIG. 1,

FIG. 4 illustrates the trimming tool assembly illustrated in FIG. 1 as viewed along a first direction indicated in FIG. 1,

FIG. 5 illustrates the trimming tool assembly illustrated in FIG. 1 as being held in an intended use position relative to an edge formation,

FIG. 6 illustrates a second perspective view of the trimming tool assembly explained with reference to FIG. 1-FIG. 5, and

FIG. 7 illustrates a cross section of a trimming tool, a gear assembly, and a portion of a tubular elongate support column of the trimming tool assembly according to the embodiments illustrated in FIG. 1-FIG. 6.

### DETAILED DESCRIPTION

Aspects of the present invention will now be described more fully. Like numbers refer to like elements throughout. Well-known functions or constructions will not necessarily be described in detail for brevity and/or clarity.

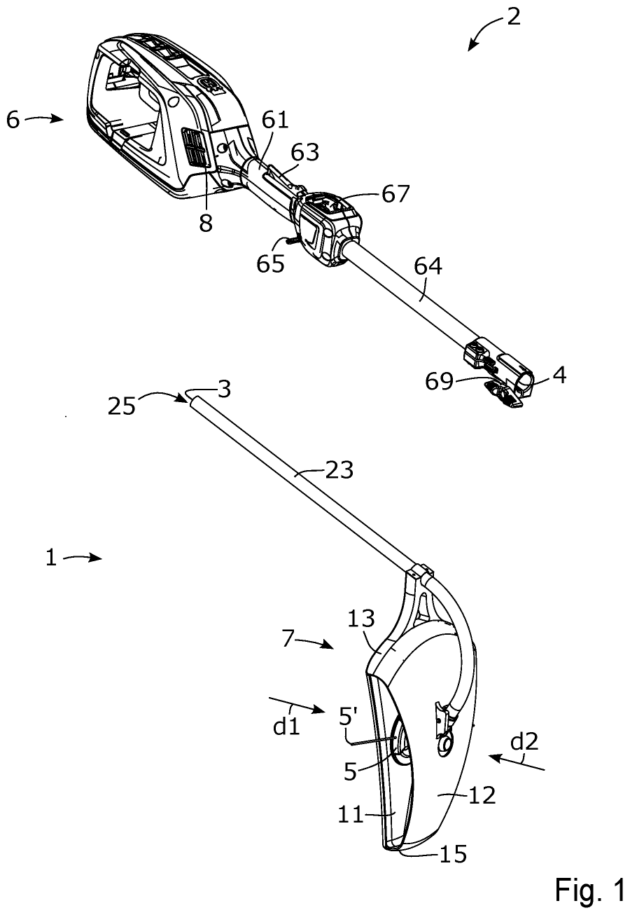

FIG. 1 illustrates a perspective view of a power tool 2 according to some embodiments of the present disclosure. The power tool 2 comprises a power unit 6 comprising an output shaft 4 and a motor 8 configured to rotate the output shaft 4. According to the illustrated embodiments, the motor 8 of the power unit 6 is an electric motor. According to further embodiments, the motor 8 of the power unit 6 may be an internal combustion engine.

According to the illustrated embodiments, the power unit 6 comprises a handle portion 61, a safety switch 63 and an actuator 65, wherein each of the safety switch 63 and the actuator 65 is arranged at the handle portion 61 of the power unit 6. Furthermore, according to the illustrated embodiments, the power unit 6 comprises a user interface 67 allowing a user to transfer the power unit 6 between an activated and a deactivated state. The user interface 67 may comprise an input unit, such as a button, knob, or the like, allowing such a transfer between the activated and the deactivated state.

According to the illustrated embodiments, the power unit 6 comprises a control arrangement configured to initiate operation of the motor 8, and thus rotation of the output shaft 4 of the power unit 6, when the power unit 6 is in the active state and each of the safety switch 63 and the actuator 65 is pressed. The drive shaft 4 of the power unit 6 is arranged inside a tubular column 64 of the power unit 6. An outside surface of the tubular column 64 may act as a second handle portion of the power unit 6.

The power tool 2 further comprises an edge trimming tool assembly 1. As is further explained herein, the edge trimming tool assembly 1 is specifically configured to cut vegetation around edge formations. For reasons of brevity and clarity, the edge trimming tool assembly 1 is in some places herein referred to as “the trimming tool assembly” or simply “the assembly 1”. Since the power tool 2 comprises a trimming tool assembly 1, the power tool 2, as referred to herein, may also be referred to as a trimmer apparatus, an edge trimmer apparatus, a grass trimmer, a string trimmer, a line trimmer, or the like.

The trimming tool assembly 1 comprising a drive shaft 3 and a trimming tool 5 connected to the drive shaft 3. As is further explained herein, the trimming tool 5 is configured to be rotated around rotation axis by the drive shaft 3 such that a radially outer portion 5′ of a trimmer line of the trimming tool 5 orbits in a circular path. According to the illustrated embodiments, the trimming tool assembly 1 comprises a tubular elongate support column 23, wherein the drive shaft 3 is arranged inside the tubular elongate support column 23. The trimming tool 5 may be any other type of trimming tool known in the art, e.g. a grass blade.

According to the illustrated embodiments, the drive shaft 3 of the trimming tool assembly 1 is connectable to the output shaft 4 of the power unit 6. In more detail, according to the illustrated embodiments, the drive shaft 3 of the trimming tool assembly 1 comprises a connection portion 25 for connecting the output shaft 4 of a power unit 6 to the drive shaft 3. The power tool 2 may comprise a splined interface between the output shaft 4 of the power unit 6 and the connection portion 25 of the drive shaft 3 of the trimming tool assembly 1. Moreover, according to the illustrated embodiments, the power tool 2 comprises a locking assembly 69 arranged on the tubular column 64 of the power unit 6 for locking the tubular column 64 against the tubular elongate support column 23 of the trimming tool assembly 1.

According to the illustrated embodiments, the trimming tool assembly 1 may be provided and sold as a separate unit intended for use with a power unit 6, such as a power unit 6 according to the embodiments illustrated in FIG. 1. However, the trimming tool assembly 1 according to the present disclosure may also be used with another type of power unit, such as a power unit comprising an internal combustion engine.

Moreover, according to further embodiments, the power tool 2 as referred to herein, may be provided and sold as a separate unit wherein the power tool 2 comprises a power unit 6 and a trimming tool assembly 1, wherein the drive shaft 3 of the trimming tool assembly 1 may be permanently connected to the output shaft 4 of the power unit 6. According to such embodiments, the output shaft 4 of the power unit 6 and the drive shaft 3 of the trimming tool assembly 1 may be different portions of the same component.

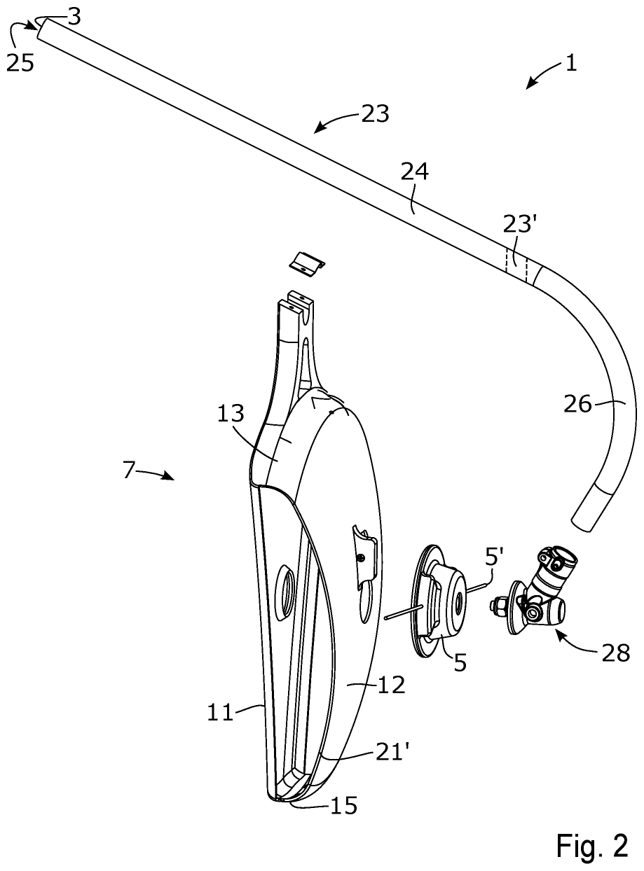

FIG. 2 illustrates an exploded view of some components of the trimming tool assembly 1 illustrated in FIG. 1. Below, simultaneous reference is made to FIG. 1 and FIG. 2, if not indicated otherwise.

According to the illustrated embodiments, the trimming tool assembly 1 comprises the elongated support column 23 with the drive shaft 3 arranged therein. Moreover, the trimming tool assembly 1 comprises a gear assembly 28, wherein the trimming tool 5 is connected to the drive shaft 3 via the gear assembly 28, as will be explained in further detail below.

Furthermore, the trimming tool assembly 1 comprises a guard 7. The guard 7 may also be referred to as a trimmer guard, or the like. The guard 7 comprises a first guard portion 11 covering a portion of the trimming tool 5 from a first side of a rotation plane of radially outer portions 5′ of the trimming tool 5. Moreover, the guard 7 comprises a second guard portion 12 covering a portion of the trimming tool 5 from a second side of the rotation plane of the radially outer portions 5′ of the trimming tool 5.

In FIG. 1, a first direction d1 and a second direction d2 are indicated. The first direction d1 points towards the first guard portion 11 of the guard 7 and is parallel to a rotation axis of the trimming tool 5. Likewise, the second direction d2 points towards the second guard portion 12 of the guard 7 and is parallel to a rotation axis of the trimming tool 5. The second direction d2 is opposite to the first direction d1.

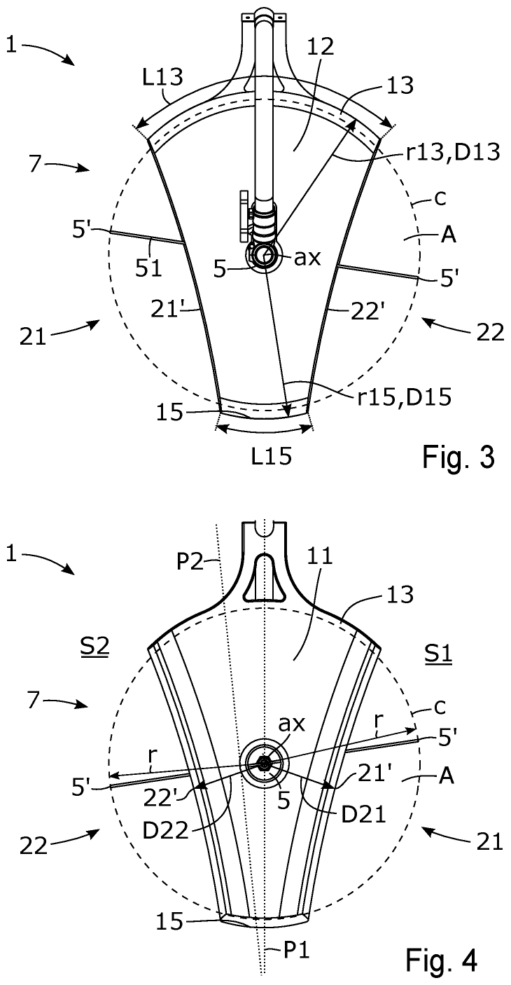

FIG. 3 illustrates the trimming tool assembly 1 illustrated in FIG. 1 as viewed along the second direction d2 indicated in FIG. 1, i.e., in a direction straight towards the second guard portion 12 of the guard 7. In FIG. 3, a portion of the tubular elongate support column 23 of the trimming tool assembly 1 has been omitted for reasons of brevity and clarity. Moreover, in FIG. 3, the rotation axis ax of the trimming tool 5 is indicated. As understood from the above, the viewing direction of FIG. 3 coincides with a direction of the rotation axis ax.

Below, simultaneous reference is made to FIG. 1-FIG. 3, if not indicated otherwise. As indicated above, the trimming tool 5 is configured to be rotated around a rotation axis ax by the drive shaft 3 such that a radially outer portion 5′ of the trimming tool 5 orbits in a circular path c in a rotation plane. The rotation plane of the radially outer portion 5′ of the trimming tool 5 is perpendicular to the rotation axis of the trimming tool 5. According to the illustrated embodiments, the radially outer portion 5′ of the trimming tool 5 is a radially outer portion 5′ of a trimmer line 51 of the trimming tool 5.

In FIG. 3, an area A formed inside the circular path c is indicated. As can be seen when comparing FIG. 1 and FIG. 3, the second guard portion 12 of the guard 7 covers a portion of the area A as seen in the second direction d2 parallel to the rotation axis ax.

FIG. 4 illustrates the trimming tool assembly 1 illustrated in FIG. 1 as viewed along the first direction d1 indicated in FIG. 1, i.e., in a direction straight towards the first guard portion 11 of the guard 7. In FIG. 4, a portion of the tubular elongate support column 23 of the trimming tool assembly 1 has been omitted for reasons of brevity and clarity. Moreover, in FIG. 4, the rotation axis ax of the trimming tool 5 is indicated. The viewing direction of FIG. 4 coincides with a direction of the rotation axis ax.

As can be seen when comparing FIG. 1 and FIG. 4, the first guard portion 11 of the guard 7 covers a portion of the area A formed inside the circular path c as seen in the first direction d1 parallel to the rotation axis ax. The area A formed inside the circular path c, as referred to herein, may also be referred to as an area A enclosed by the circular path c of the radially outer portion 5′ of the trimming tool 5.

Below, simultaneous reference is made to FIG. 1-FIG. 4, if not indicated otherwise. The area A formed inside the circular path c may be calculated by squaring an effective radius r of the trimming tool 5 and multiplying the squared effective radius r by π. The effective radius r may be an intended effective radius r of the trimming tool 5 and may correspond to a radius of a trimmer line 51 of intended length, when being stretched in a radial direction from the rotation axis ax of the trimming tool 5, measured in the radial direction from the rotation axis ax of the trimming tool 5 to the radially outer portion 5′ of the trimming tool 5.

Since the guard 7 comprises the first and second guard portions 11, 12, a trimming tool assembly 1 is provided having conditions for cutting vegetation around edge formations in a simple, ergonomic, and safer manner, while providing conditions for an improved cutting result, as is further explained herein.

Moreover, due to the first and second guard portions 11, 12 of the guard 7 each covering a portion of the area A as seen in respective direction parallel to the rotation axis, a trimming tool assembly 1 is provided allowing a safer and more ergonomic operation of the trimming tool assembly 1 with the trimming tool 5 being held such that the rotation plane of the radially outer portion 5′ of the trimming tool 5 is substantially vertical, as is further explained herein.

According to the illustrated embodiments, each of the first and second guard portions 11, 12 covers approximately 65% of the area A as seen in the respective first and second directions d1, d2. According to further embodiments, each of the first and second guard portions 11, 12 may cover more than 30%, or more than 50%, of the area A as seen in the respective first and second directions d1, d2.

Moreover, as seen when comparing FIG. 3 and FIG. 4, according to the illustrated embodiments, each of the first and second guard portions 11, 12 superimposes approximately 100% of the other of the first and second guard portions 11, 12 as seen along the respective first and second directions d1, d2. In other words, according to the illustrated embodiments, the surface area of the first guard portion 11 as seen in the first direction d1 substantially corresponds to the surface area of the second guard portion 12 as seen in the second direction d2. According to further embodiments, each of the first and second guard portions 11, 12 may superimpose at least 70%, or at least 85%, of the other of the first and second guard portions 11, 12 as seen along the respective first and second directions d1, d2.

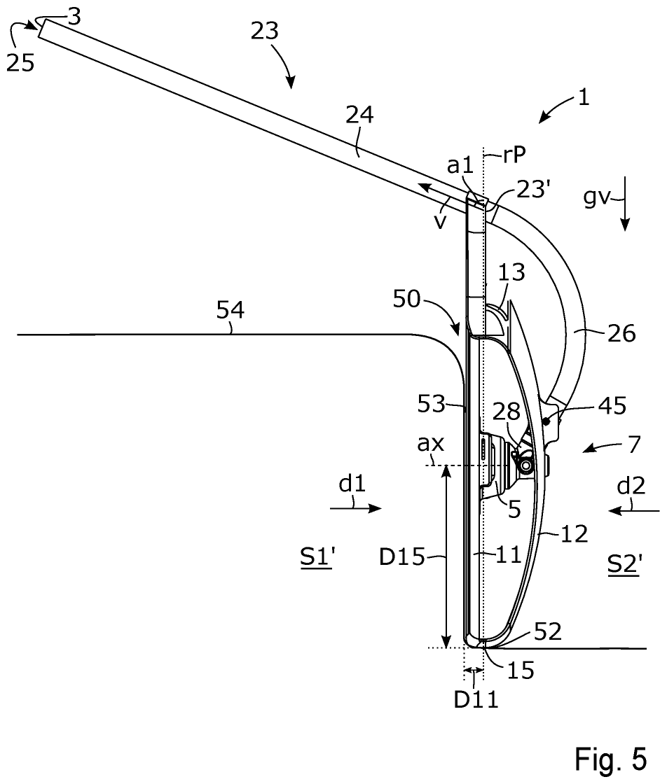

FIG. 5 illustrates the trimming tool assembly 1 illustrated in FIG. 1 as being held in an intended use position relative to an edge formation 50.

As is indicated in FIG. 5, the guard 7 is attached to an attachment section 23′ of the tubular elongate support column 23. The attachment section 23′ is also indicated in FIG. 2. In FIG. 5, the rotation plane rP of the radially outer portion of the trimming tool 5 is indicated.

As can be seen in FIG. 5, according to the illustrated embodiments, each of the connection portion 25 of the drive shaft 3 and the first guard portion 11 is arranged on a first side S1′ of the rotation plane rP whereas the gear assembly 28 is arranged on a second side S2′ of the rotation plane rP, wherein the second side S2′ is opposite to the first side S1′.

According to the illustrated embodiments, the angle a1 between the rotation plane rP a vector v pointing from the attachment section 23′ towards the connection portion 25 is approximately 69 degrees. According to further embodiments, the angle a1 between the rotation plane rP a vector v pointing from the attachment section 23′ towards the connection portion 25 may be within the range of 10-85 degrees, or may be within the range of 59-79 degrees. According to the illustrated embodiments, the angle a1 is measured in a plane comprising the rotation axis, i.e., in a plane perpendicular to the rotation plane rP of the trimming tool 5.

Below, simultaneous reference is made to FIG. 1-FIG. 5, if not indicated otherwise. According to the illustrated embodiments, the drive shaft 3 of the trimming tool assembly 1 is flexible, wherein the tubular elongate support column 23 has a curved portion 26. Moreover, according to the illustrated embodiments, the curved portion 26 is arranged between the attachment section 23′ and the trimming tool 5. Furthermore, according to the illustrated embodiments, a portion 24 of the tubular elongate support column 23 located between the attachment section 23′ and the connection portion 25 is substantially straight.

According to further embodiments, also the portion 24 of the tubular elongate support column 23 located between the attachment section 23′ and the connection portion 25 may comprise one or more curved portions. Furthermore, according to some embodiments, the drive shaft 3 of the trimming tool assembly 1 may be rigid wherein all sections of the tubular elongate support column 23 are substantially straight. According to such embodiments, as well as other embodiments of the herein described, the trimming tool assembly 1 may comprise one or more further gear assemblies 28 than depicted in FIG. 2 and FIG. 5.

As indicated in FIG. 1-FIG. 5, according to the illustrated embodiments, the cutting guard 7 comprises a first edge portion 13 arranged radially outside of the trimming tool 5, wherein the first edge portion 13 connects the first and second guard portions 11, 12. According to the illustrated embodiments, the tubular elongate support column 23 is attached to the first edge portion 13 of the guard 7. However, the guard 7 may be attached to the tubular elongate support column 23 in another manner.

As is indicated in FIG. 3, according to the illustrated embodiments, the first edge portion 13 is arc-shaped with a radius of curvature r13 being approximately 100% of the distance D13 between the rotation axis ax and the first edge portion 13. According to further embodiments, the radius of curvature r13 of the first edge portion 13 may be within the range of 80-130% of the distance D13 between the rotation axis ax and the first edge portion 13. The distance D13 between the rotation axis ax and the first edge portion 13 may be measured between the rotation axis ax of the trimming tool 5 and a radially outer portion of the first edge portion 13.

Moreover, according to the illustrated embodiments, the arc length L13 of the first edge portion 13 is approximately 155% of the distance D13 between the rotation axis ax and the first edge portion 13. According to further embodiments, the arc length L13 of the first edge portion 13 may be within the range of 50-500%, or may be within the range of 100-250%, of the distance D13 between the rotation axis ax and the first edge portion 13.

In this manner, the first edge portion 13 can prevent splashing of cutting residues and other types of objects and particles from the trimming tool 5 in an efficient manner during operation of the trimming tool assembly 1.

Moreover, as is indicated in FIG. 1-FIG. 5, according to the illustrated embodiments, the guard 7 comprises a second edge portion 15. According to the illustrated embodiments, the second edge portion 15 is arranged opposite to the first edge portion 13 and also connects first and second guard portions 11, 12. According to further embodiments, the guard 7 may comprise an open section radially outside of the trimming tool 5 at a location opposite to the first edge portion 13.

The fact that each of the first and second edge portions 13, 15 connects the first and second guard portions 11, 12 according to the illustrated embodiments means that the guard 7 encloses the trimming tool 5 in a plane P2 parallel to the rotation axis ax, as is indicated in FIG. 4.

As is indicated in FIG. 3, according to the illustrated embodiments, the second edge portion 15 is arc-shaped with a radius of curvature r15 being approximately 100% of the distance D15 between the rotation axis ax and the second edge portion 15. According to further embodiments, the radius of curvature r15 of the second edge portion 15 may be within the range of 80-130% of the distance D15 between the rotation axis ax and the second edge portion 15

According to the illustrated embodiments, the arc length L15 of the second edge portion 15 is approximately 57% of the distance D15 between the rotation axis ax and the second edge portion 15. According to further embodiments, the arc length L15 of the second edge portion 15 may be within the range of 3-180%, or may be within the range of 25-90%, of the distance D15 between the rotation axis ax and the second edge portion 15. The distance D15 between the rotation axis ax and the second edge portion 15 may be measured between the rotation axis ax of the trimming tool 5 and a radially outer portion of the second edge portion 15.

In FIG. 4, a plane P1 comprising the rotation axis ax of the trimming tool 5 is indicated. Since the plane P1 comprises the rotation axis ax, the plane P1 extends through the rotation axis ax and is parallel to the rotation axis ax. Moreover, according to the illustrated embodiments, the plane P1 extends through the tubular elongate support column 23 of the trimming tool assembly 1.

As can be seen in FIG. 1-FIG. 5, according to the illustrated embodiments, the first and second guard portions 11, 12 and the first and second edge portions 13, 15 together form a disc-shaped object having one cut-out section on either side of the plane P1 comprising the rotation axis ax.

In other words, as is indicated in FIG. 4, according to the illustrated embodiments, the guard 7 comprises a first aperture 21 at a first side S1 of a plane P1 comprising the rotation axis ax and a second aperture 22 at a second side S2 of the plane P1 comprising the rotation axis ax. Moreover, as can be seen in FIG. 4, the trimming tool 5 has an effective radius r being greater than a distance D21 from the rotation axis ax to edges 21′ of the first aperture 21 and an effective radius r being greater than a distance D22 from the rotation axis ax to edges 22′ of the second aperture 22. In this manner, the trimming tool assembly 1 can be used in a convenient, efficient, and safe manner for cutting vegetation around edge formations 50, as is further explained below.

According to the illustrated embodiments, the plane P1 forms a symmetry plane of the guard 7, wherein the design and the measurements of the guard 7 at the second side S2 of the plane P1 substantially corresponds to the design and the measurements of the guard 7 at the first side S1 of the plane P1. In other words, according to the illustrated embodiments, the design and the measurements of the guard 7 at the second side S2 of the plane P1 substantially corresponds to a mirror image of the design and the measurements of the guard 7 at the first side S1 of the plane P1. Therefore, the plane P1, as referred to herein, may also be referred to as a symmetry plane P1 of the guard 7.

The edges 21′, 22′ of the first and second apertures 21, 22 form delimiting surfaces of the cut-out sections of the disc-shaped object referred to above, i.e., the disc-shaped object formed by the first and second guard portions 11, 12 and the first and second edge portions 13, 15 of the guard 7. As is best seen in FIG. 3 and FIG. 4, according to the illustrated embodiments, the edges 21′, 22′ of the first and second apertures 21, 22 are concave in a plane parallel to the rotation plane of the trimming tool 5 and each has a radius of curvature being greater than the effective radius r of the trimming tool 5. However, according to further embodiments, the guard 7 and the first and second apertures 21, 22 may have another design.

As is indicated in FIG. 5, according to the illustrated embodiments, the second edge portion 15 forms a ground engaging portion for maintaining a predetermined distance D15 between the rotation axis ax and a ground surface 52 by an abutting contact against the ground surface 52.

In more detail, in the example of FIG. 5, the edge formation 50 comprises a vertical section 53 and a ground surface 52 located adjacent to the vertical section 53 and below the vertical section 53 as seen relative to a local gravity vector gv. The vertical section 53 of the edge formation 50 is substantially parallel to the local gravity vector. Moreover, in FIG. 5 a second ground surface 54 is indicated.

As indicated above, in FIG. 5, the trimming tool assembly 1 is illustrated in an intended use position relative to the edge formation 50. In the intended use position of the trimming tool assembly 1 according to embodiments herein, the rotation plane rP of the trimming tool 5 is substantially parallel to the local gravity vector gv. In other words, the rotation axis ax of the trimming tool 5 is substantially perpendicular to the local gravity vector gv when the trimming tool assembly 1 according to embodiments herein is in the intended use position. Moreover, according to the illustrated embodiments, the trimming tool assembly 1 is configured such that the rotation axis ax of the trimming tool 5 points in a direction towards a user of the trimming tool assembly 1, as is further explained herein.

As mentioned, and as can be seen in FIG. 5, the second edge portion 15 can be used for maintaining a predetermined distance D15 between the rotation axis ax and a ground surface 52 by an abutting contact against the ground surface 52. Moreover, the first guard portion 11 is configured to maintain a predetermined distance D11 between the rotation plane rP of the trimming tool 5 and more or less vertical sections 53 of edge formations 50 by an abutting contact against more or less vertical sections 53 of edge formations 50.

Thus, due to the features of the trimming tool assembly 1, a user can guide the trimming tool assembly 1 such that the guard 7 and the trimming tool 5 is moved sideways along edge formations 50, in either direction, to cut vegetation at more or less vertical sections 53 of edge formations in a safer, quicker, and more convenient manner. Since the first guard portion 11 can be used to maintain a predetermined distance D11 between the rotation plane rP of the trimming tool 5 and more or less vertical sections 53 of edge formations 50, a predetermined and even cutting height can be obtained at the and more or less vertical sections 53 of the edge formation 50. The second edge portion 15 can be used for maintaining a predetermined distance D15 between the rotation axis ax and a ground surface 52 thereby avoiding splashing of matter, such as sand, from the ground surface 52.

In the example illustrated in FIG. 5, a user may stand on the second ground surface 54 indicated in FIG. 5. However, even if not optimal, the user may stand on the ground surface 52 and may utilize the second guard portion 12 for maintaining a predetermined distance between the rotation plane rP of the trimming tool 5 and the vertical section 53 of the edge formation 50.

According to the illustrated embodiments, the predetermined distances D11, D15 are fixed predetermined distances D11, D15. However, according to further embodiments, one or more portions of the guard 7 may be adjustably arranged relative to the trimming tool 5 to allow a user to adjust one or both of the predetermined distances D11, D15.

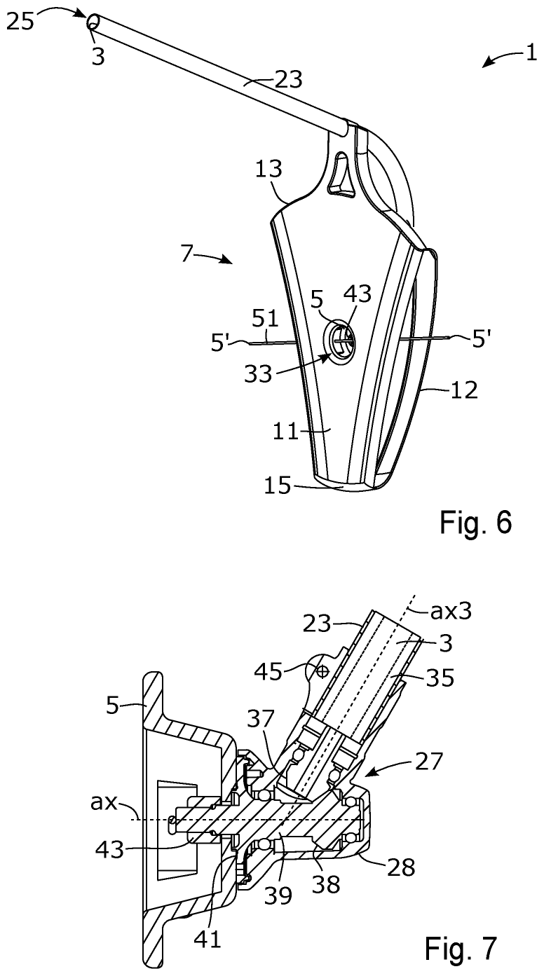

FIG. 6 illustrates a second perspective view of the trimming tool assembly 1 explained with reference to FIG. 1-FIG. 5. As is best seen in FIG. 6, according to the illustrated embodiments, the first guard portion 11 of the guard 7 comprises a centre opening 33. The centre opening 33 superimposes at least part of the trimming tool 5 as seen along the first direction indicated in FIG. 1. The rotation axis of the trimming tool 5 extends through the centre opening 33.

FIG. 7 illustrates a cross section of the trimming tool 5, the gear assembly 28, and a portion of the tubular elongate support column 23 of the trimming tool assembly 1 according to the embodiments illustrated in FIG. 1-FIG. 6. Moreover, in FIG. 7, a portion of the drive shaft 3 can be seen.

As mentioned, the drive shaft 3 may be flexible. According to such embodiments, the drive shaft 3 may comprise a high-tensile wire wound, a coil shaped body, or the like, designed to transmit rotary motion and power through a curved path. According to the illustrated embodiments, the tubular elongate support column 23 comprises a liner 35 acting as a protective outer casing for the drive shaft 3 such that the drive shaft 3 can rotate smoothly also at curved sections of the tubular elongate support column 23.

According to the illustrated embodiments, the gear assembly 28 comprises a first bevel gear 37 connected to the drive shaft 3 and a second bevel gear 38 connected to a trimmer unit shaft 39. The trimming tool shaft 39 comprises an attachment section 41 for attachment of the trimming tool 5 to the trimming tool shaft 39. According to the illustrated embodiments, the trimming tool 5 is attached to the attachment section 41 of the trimming tool shaft 39 by a fastener 43. According to the illustrated embodiments, the fastener 43 is a nut threaded onto a threaded portion of the trimming tool shaft 39. According to further embodiments, the trimming tool 5 may be attached to the attachment section 41 of the trimming tool shaft 39 in another manner, for example by another type of fastener, such as a bolt.

The centre opening 33, indicated in FIG. 6, allows a user to access the fastener 43 in a quick and continent manner without having to disassemble the guard 7 of the trimming tool assembly 1. According to the illustrated embodiments, the gear assembly 28 is attached to the second guard portion 12 of the guard 7 at an attachment section 45 of the gear assembly 28. The attachment section 45 of the gear assembly 28 is also indicated in FIG. 5. The gear assembly 28 may be attached to the second guard portion 12 of the guard 7 by an elongated fastening element protruding into the attachment section 45 of the gear assembly 28.

According to the illustrated embodiments, the centre opening 33 has a circular shape and has a diameter smaller than the diameter of the trimming tool 5, measured in a direction perpendicular to the rotation axis ax of the trimming tool 5. A user of the trimming tool assembly 1 according to the illustrated embodiments may remove the trimming tool 5 from the guard 7 by removing the fastener 43 from the threaded portion of the trimming tool shaft 39 and removing an elongated fastener protruding into the attachment section 45 of the gear assembly 28. Then, the user may remove the trimming tool 5 from the guard 7 via one of the first and second apertures 21, 22 indicated in FIG. 4 and FIG. 5. In this manner, the user can remove the trimming tool 5 from the guard 7 in a quick and continent manner without having to disassemble the guard 7 of the trimming tool assembly 1.

The user may want to remove the trimming tool 5 from the guard 7 for example when wanting to perform service and maintenance of the trimming tool 5, when wanting to clean the trimming tool 5 and/or the guard 7, and/or when wanting to replace the trimmer line 51 of the trimming tool 5. However, according to the illustrated embodiments, the user may also replace the trimmer line 51 of the trimming tool 5 without having to remove the trimming tool 5 from the guard 7 by accessing the trimming tool 5 via one or both of the first and second apertures 21, 22 indicated in FIG. 4 and FIG. 5.

As understood from the above, the trimming tool shaft 39 is configured to rotate around the rotation axis ax of the trimming tool 5 during operation. The first and second bevel gears 37, 38 form a bevel gear assembly 27, wherein the trimming tool 5 is connected to the drive shaft 3 via the bevel gear assembly 27. The bevel gear assembly 27 allows the rotation axis ax3 of the drive shaft 3 to be angled relative to the rotation axis ax of the trimming tool 5. Thus, the bevel gear assembly 27 reduces the need for a large curvature of the tubular elongate support column 23. According to further embodiments, the trimming tool assembly 1 may comprise another type of gear assembly, such as a spur gear assembly, or the like.

The following is explained with simultaneous reference to FIG. 1-FIG. 7.

The wording “substantially parallel to”, as used herein, may encompass that the angle between the objects referred to is less than 10 degrees, or is less than 7 degrees.

The wording “substantially perpendicular to”, as used herein, may encompass that the angle between the objects referred to is within the range of 80-100 degrees or is within the range of 83-97 degrees.

The wording “substantially straight”, as used herein, may encompass that the object referred to deviates less than 10% from the shape of a flat plane.

The wording “substantially vertical”, as used herein, may encompass that the angle between the object referred to and a local gravity vector gv at the location of the trimming tool assembly 1 is less than 20 degrees, or is less than 10 degrees.

The wording “substantially corresponds to”, as used herein, may encompass that the aspects, objects, distances, or measurements referred to deviates less than 10% from each other.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. An edge trimming tool assembly configured to cut vegetation around edge formations, the assembly comprising a drive shaft and a trimming tool connected to the drive shaft,
wherein the trimming tool is configured to be rotated around a rotation axis by the drive shaft such that a radially outer portion of the trimming tool orbits in a circular path in a rotation plane,
wherein the assembly comprises a guard comprising a first guard portion covering a portion of an area formed inside the circular path as seen in a first direction parallel to the rotation axis and a second guard portion covering a portion of the area as seen in a second direction parallel to the rotation axis, wherein the second direction is opposite to the first direction,
wherein the guard comprises a second edge portion arranged opposite to the first edge portion,
wherein the second edge portion forms a ground engaging portion for maintaining a predetermined distance between the rotation axis and a ground surface by an abutting contact against the ground surface.

2. The assembly according to claim 1, wherein each of the first and second guard portions covers more than 30%, or more than 50%, of the area as seen in the respective first and second directions.

3. The assembly according to claim 1, wherein each of the first and second guard portions superimposes at least 70% of the other of the first and second guard portions as seen along the respective first and second directions.

4. The assembly according to claim 1, wherein the trimming tool comprises a tubular elongate support column, wherein the drive shaft is arranged inside the tubular elongate support column and comprises a connection portion for connecting an output shaft of a power unit to the drive shaft.

5. The assembly according to claim 4, wherein the guard is attached to an attachment section of the tubular elongate support column, and wherein the angle between the rotation plane a vector pointing from the attachment section towards the connection portion is within a range of 10-85 degrees.

6. The assembly according to claim 4, wherein the drive shaft is flexible, and wherein the tubular elongate support column has a curved portion.

7. The assembly according to claim 4, wherein each of the connection portion and the first guard portion is arranged on a first side of the rotation plane.

8. The assembly according to claim 1, wherein the cutting guard comprises a first edge portion arranged radially outside of the trimming tool, and wherein the first edge portion connects the first and second guard portions.

9. The assembly according to claim 1, wherein the second edge portion connects first and second guard portions.

10. The assembly according to claim 1, wherein the second edge portion is arc-shaped with a radius of curvature being within a range of 80-130% of the distance between the rotation axis and the second edge portion.

11. The assembly according to claim 1, wherein the guard encloses the trimming tool in a plane parallel to the rotation axis.

12. The assembly according to claim 1, wherein the guard comprises a first aperture at a first side of a plane comprising the rotation axis, and wherein the trimming tool has an effective radius being greater than a distance from the rotation axis to edges of the first aperture.

13. The assembly according to claim 12, wherein the guard comprises a second aperture at a second side of the plane, and wherein the trimming tool has an effective radius being greater than a distance from the rotation axis to edges of the second aperture.

14. The assembly according to claim 1, wherein the trimming tool comprises a bevel gear assembly, and wherein the trimming tool is connected to the drive shaft via the bevel gear assembly.

15. A power tool comprising:
a power unit comprising an output shaft and a motor configured to rotate the output shaft, and
an edge trimming tool assembly wherein the drive shaft of the edge trimming tool assembly is connected, or connectable, to the output shaft of the power unit.
